(19) United States
(12) Patent Application Publication
(10) Pub. No.: US 2003/0160767 A1
(43) Pub. Date: Aug. 28, 2003

(54) Wireless detachable display

(75) Inventors: Yoon Kean Wong, Redwood City, CA (US); William R. Hanson, Mountain View, CA (US); Lawrence Lam, San Jose, CA (US); Mark W. Oliver, Fox River Grove, IL (US)

Correspondence Address: FOLEY & LARDNER, 777 EAST WISCONSIN AVENUE, SUITE 3800, MILWAUKEE, WI, 53202-5308, US

(73) Assignee: Palm Inc.

(21) Appl. No.: 10/085,924

(22) Filed: Feb. 28, 2002

(51) Int. Cl. G09G 5/00

(52) U.S. Cl. 345/169

(57) ABSTRACT

A wireless detachable display for a handheld computing device is disclosed. The display system includes a visual display having a communications transceiver, a processing unit having a communications transceiver and sending display data to the transceiver of the visual display, a first power source for the processing unit, and a second power source for the visual display. The visual display is physically separable from the processing unit while displaying information according to communications from the processing unit between the visual display transceiver and the processing unit transceiver.

### CROSS REFERENCE TO RELATED APPLICATIONS

The present application is related to U.S. patent App. Ser. No. ______, Atty. Dkt. No. 035451-0174, entitled DETACHABLE EXPANDABLE FLEXIBLE DISPLAY, and U.S. patent App. Ser. No. ______, Atty. Dkt. No. 035451-0185, entitled INTERCHANGEABLE DISPLAY MODULES FOR PORTABLE HANDHELD DEVICES, both of which are filed on the same day herewith and assigned to the same assignee as the present application and are both herein incorporated by reference.

### BACKGROUND

The disclosure relates generally to the field of handheld computing devices. More particularly, the disclosure relates to a wireless detachable display for a handheld computing device.

Handheld computing devices usually display data stored in memory or generated by a processor on a visual display that is slightly smaller than the size of the handheld computing device. The size of a handheld computing device is generally compact and correspondingly the visual display is also compact. Consequently, the visual display for a handheld computing device is significantly smaller than the size of a standard computer monitor. The small size of the visual display has prompted handheld computing devices to focus on displaying abbreviated or simplistic content.

Displaying abbreviated or simplistic content has not been an issue however because handheld computing devices have also had limited computing power. When handheld computing devices were introduced, most people were using the devices for relatively simple applications. Traditional applications may have included an address book, a daily planner, or other similar applications that are generally not graphic intensive. These applications worked well with the smaller display screens.

However, the capabilities of handheld computing devices are evolving rapidly and showing significant improvements. Handheld computing devices have improved in processor power, battery life, weight, etc. As a consequence of these improvements, handheld computing devices are now running applications that were formerly only run on full personal computers.

However, handheld computers are still limited by the relatively small display screen size. It would be undesirable to display the full content of a screen normally displayed on a 15 inch computer monitor on a traditional handheld computing device screen. Increasing the size of a traditional handheld computing device display screen would cause a corresponding increase in the size and weight of the handheld computing device. However, consumer demand trends generally require smaller and lighter handheld computing devices.

Accordingly, there is a need for a display screen that can display data from a handheld computer on a larger screen without substantially increasing the size or weight of the handheld computing device. Further, there is a need for a handheld computing device having a removable or detachable display.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

One embodiment of the invention relates to a display system for a handheld computing device. The display system includes a visual display having a communications transceiver and a processing unit having a communications transceiver. The processing unit transceiver sends display data to the transceiver of the visual display. A first power source for the processing unit, and a second power source for the visual display are also included. The visual display is physically separable from the processing unit while displaying information according to communications from the processing unit between the visual display transceiver and the processing unit transceiver.

Another exemplary embodiment relates to a handheld computing device. The handheld computing device includes a detachable display system including a wireless transceiver, and a processor. The handheld computing device also includes a wireless transceiver coupled to the processor and communicating with the display system transceiver. Further, the handheld computing device includes an information storage system.

Another exemplary embodiment relates to a computing system. The computing system includes a processing unit. The processing unit includes a first processor, a first transceiver coupled to the first processor, a first memory coupled to the first processor, and a first power source coupled to the first processor. The computing system also includes a first display unit. The first display unit includes a first display area, a second processor, a second transceiver coupled to the second processor and communicating with the first transceiver, a second memory coupled to the second processor, and a second power source coupled to the second processor. Further, the computing system includes a second display unit. The second display unit includes a second display area, a third processor, a third transceiver coupled to the third processor and configured for communications with the first transceiver. A third power source is coupled to the third processor. The first display unit and the second display unit may be interchangably used with the processing unit.

Another exemplary embodiment relates to a method of displaying data from a handheld computing device on a detached visual display unit. The method includes wirelessly communicating primary images to the visual display unit. The method also includes displaying primary images on a visual display of the visual display unit while loading secondary images into a visual display unit memory. Further, the method includes allowing a user of the handheld computing device to access the secondary images.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a general block diagram of a handheld computing device including a processing unit in communication over a wireless connection with a visual display system in accordance with an exemplary embodiment;

FIG. 1B is a general block diagram of a handheld computing device including a processing unit in communication over a wireless connection with an alternative visual display system;

FIG. 2 is a general block diagram of a handheld computing device including a processing unit in communication over a wireless connection with a variety of alternative visual display systems;

FIG. 3 is a general block diagram of a handheld computing device including a processing unit in communication over a wireless connection with an expandable visual display system;

FIG. 4 is a general block diagram of a user of a handheld computing device utilizing a detached visual display system while wearing a processing unit on a belt; and

FIG. 5 is a flow diagram illustrating a process of using a handheld computing device including loading and displaying information on a visual display system over a wireless connection from a processing unit and utilizing a background process to increase response time.

### DETAILED DESCRIPTION OF PREFERRED AND EXEMPLARY EMBODIMENTS

A system and method for providing a wireless detachable display for a handheld computing device is described. In the following description, for purposes of explanation, numerous specific details are set forth to provide a through understanding of exemplary embodiments of the invention. It will be evident, however, to one skilled in the art that the invention may be practiced without these specific details. In other instances, structures and devices are shown in block diagram form to facilitate description of the exemplary embodiments.

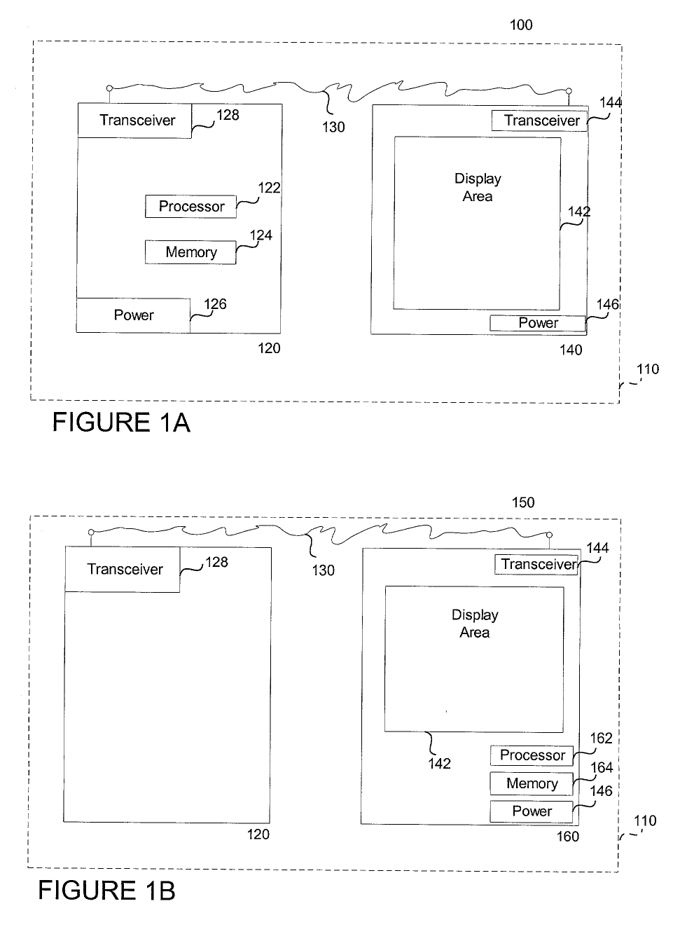

FIG. 1A is a general block diagram 100 of a handheld computing device 110 including a processing unit 120 in communication over a wireless connection 130 with a visual display system 140 in accordance with an exemplary embodiment.

Processing unit 120 can be a handheld computer, a handheld personal digital assistant, a wireless cellular digital phone, a pager, or any other such device. Processing unit 120 can be communicatively coupled to a wireless connection 130.

According to an exemplary embodiment, processing unit 120 includes a processing unit central processor 122, a processing unit memory 124, a processing unit power source 126, and a processing unit wireless transceiver 128. Processing unit central processor 122 can be any microprocessor capable of accessing information stored in processing unit memory 124, performing actions using information from any source, and alternatively storing information in processing unit memory 124 or transmitting information to visual display system 140.

Processing unit memory 124 can be any form of data storage. It may be at least one of random access memory (RAM) and/or read only memory (ROM). Information can be stored permanently until overwritten and/or stored temporarily for use while the unit is active.

Processing unit power source 126 can be a battery, a direct line from a wall outlet, current from a solar cell, or any other power source sufficient to satisfy the power requirement for processing unit 120.

Processing unit wireless transceiver 128 can be any transceiver capable of sending and receiving data over a wireless connection. According to an exemplary embodiment, processing unit wireless transceiver 128 can be a device using the Infrared Direct Access (IrDA) protocol, the Bluetooth short range radio network protocol, the IEEE 802.11 protocol, the HomeRF single wireless access protocol, the IEEE 802.11 b wireless fidelity protocol, or any other protocol for sending information wirelessly from processing unit 120 to visual display system 140.

According to an exemplary embodiment, wireless connection 130 is a wireless connection using any of the wireless communication protocols discussed in reference to wireless transceiver 128 or any other wireless communication protocol. In alternative embodiments, wireless connection 130 is a connection utilizing any type of network such as, a virtual private network, an intranet, an Ethernet, or a NetWare network.

According to an exemplary embodiment, visual display system 140 includes a display area 142, a display unit wireless transceiver 144, and a display unit power source 146. According to an exemplary embodiment, display area 142 can be an LCD screen, e-paper (e-Ink, Smart Paper™ by Gyricon Media, or APD™ by Citala, etc.), other forms of bi-stable displays, or any other type of visual display. Display unit wireless transceiver 144 can be any type of wireless transceiver as described above in reference to processing unit transceiver 128. Display unit power source 146 can be any power source capable of satisfying the power requirements for visual display system 140.

According to an exemplary embodiment, handheld computing device 110 can process information in processing unit 120 for display on the visual display system 140. The information is sent from processing unit 120, over wireless connection 130, to visual display system 140. This system allows the user the option of separating visual display system 140 from processing unit 120. Separating the units allows the user to store processing unit 120 in a pocket, desk, or briefcase while viewing information on visual display system 140. Separating the units also has the advantage that the weight of processing unit 120 does not have to be carried or held up while the user is viewing information on visual display system 140. Separating the units also has the advantage that visual display system 140 can feature a larger display area 142 without increasing the weight that the user is carrying in their hands while viewing information.

FIG. 1B is a general block diagram 150 of a handheld computing device 110 including a processing unit 120 and an alternative visual display system 1 60. Visual display system 1 60 can include a display area 142, display unit wireless transceiver 144, and display unit power source 146 as described above. According to an exemplary embodiment, visual display system 160 can also include a display unit processor 162 and a display unit memory 164. Display unit processor 162 can be any processing unit as described in reference to processing unit processor 122. Display unit memory 164 can be any memory as described in reference to processing unit memory 124.

According to an exemplary embodiment, visual display system 160 can utilize display unit processor 162 to store information in display unit memory 164. In addition, visual display system 160 can utilize display unit processor 162 to receive information for display unit wireless transceiver 144, execute instructions using that information or user input information, and display the results in the display area 142 or store the results in display unit memory 164.

According to an exemplary embodiment, display unit processor 162 can receive information related to the image currently being displayed in display area 142 (current display image). Display unit processor 162 can receive the information from display unit wireless transceiver 144 and store the information in display unit memory 164. According to an exemplary embodiment, the information can be data referenced by hypertext links in the current display image. According to another exemplary embodiment, the information can be a full sized image represented by a thumbnail image in the current display image. Loading information related to an image currently being displayed into memory has the advantage of dramatically speeding response time when the related information is requested for display. The process of receiving information and storing the information in display unit memory 164 can be performed in the background while wireless connection 130 is otherwise idle.

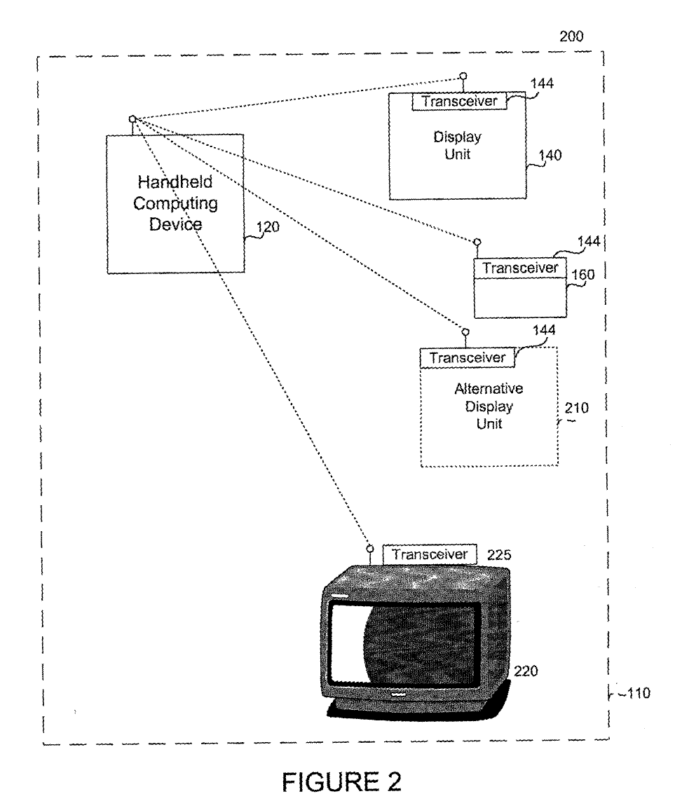

FIG. 2 is a general block diagram 200 of a handheld computing device 1 10 including processing unit 120 in wireless communication with a variety of visual display systems. According to an exemplary embodiment, the visual display system can be visual display system 140 or visual display system 160 described above with reference to FIGS. 1A and 1B.

According to an alternative embodiment, the visual display system can be visual display system 210, including display unit wireless transceiver 144. Visual display system 210 features different properties from visual display system 140. Visual display system 210 can be a whiteboard, an upgraded visual display, a color display, a monochrome display, or any other display capable of display data transmitted from processing unit 120. Advantageously the ability to use different displays with different properties allows the user to choose a visual display system to meet current requirements. The user of the handheld computing device 110 can display data on a display featuring more color depth if need for a particular type of information, for example to display a photograph. Alternative, the user may require a larger display for making a presentation. This visual display system may have greater power requirements or be more expensive compared to a smaller, less colorful display. Another alternative visual display could allow the user to chose a smaller display to access data while travelling.

According to an additional alternative embodiment, the visual display system can be a television 220, including display unit wireless transceiver 225. Television transceiver 225 can be any type of wireless transceiver as discussed above in reference to processing unit wireless transceiver 144. Television transceiver 225 could have the additional capability to convert the display signal for display on a standard television. This embodiment has the advantage of allowing the user to have a large display area available anywhere a television is available.

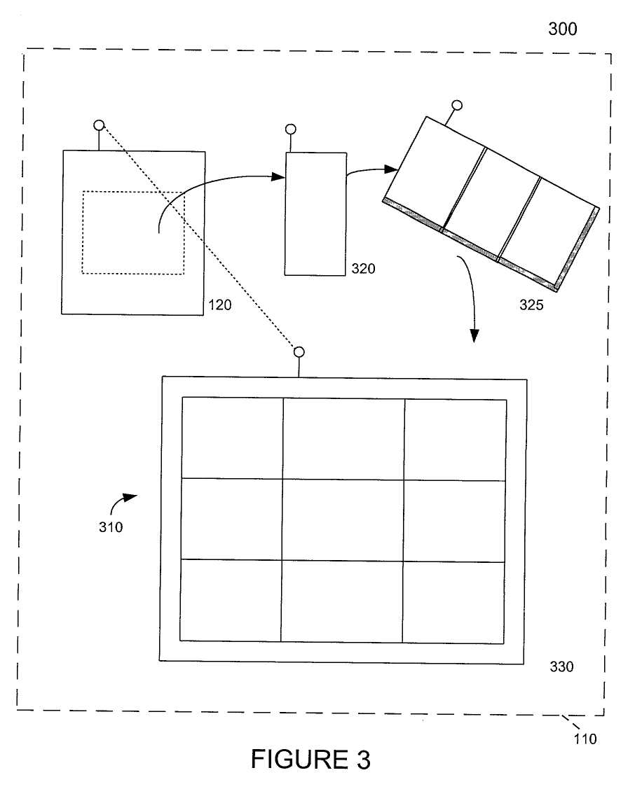

FIG. 3 is a general block diagram 300 of a handheld computing device 110 including processing unit 120 in wireless communication with an expandable visual display system 310. Visual display system 310 is shown in a compact state 320, a partially unfolded state 325 and in a fully expanded state 330. According to an exemplary embodiment, visual display system 310 is implemented using e-paper or other bistable display technology. According to an alternative embodiment, visual display 310 can be implemented using a hinged LCD visual display or any other visual display that can be transformed to a compact size.

According to an exemplary embodiment, visual display system 310 can be in a folded or compact state as shown at 320 or can be opened to present a large viewing area as shown at 330. The display can present a display area in either its compact state or in its fully expanded state. Display 310 can be implemented using e paper, e ink, and shutter technology or any other technology that would allow an expandable display with multiple viewing states. Presenting a display area in different states of expansion allows the user of the handheld computing device to use the display most suitable for current needs. A compact display could be desirable when checking a daily planner entry or looking up a contact while travelling. In contrast, a larger display may be appropriate when reading a large document or viewing a large image.

According to an exemplary embodiment, processing unit 120 sends data over wireless connection 130 to visual display system 310. Visual display system 310 can be very lightweight while still presenting a very large viewing area. Having a lightweight display unit allows the user to hold visual display system 310 in the same manner as a newspaper or book for viewing. Additionally, visual display system 310 can feature display unit processor 162 and display unit memory 164 to allow the user to quickly “turn pages” to view additional information.

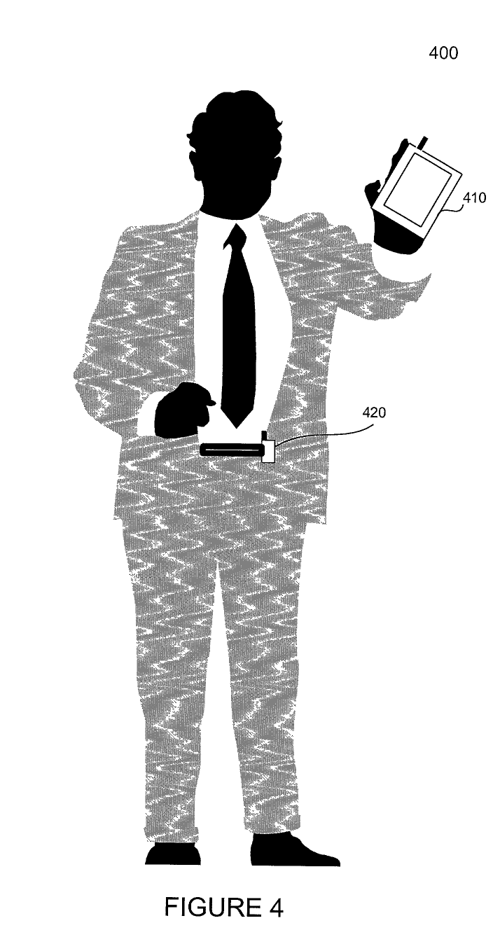

FIG. 4 is a diagram of a user of handheld computing device 110 holding a visual display system 410 while a processing unit 420 is attached to the user's belt. According to an exemplary embodiment, the processing unit 420 can include a larger battery. A larger battery included in processing unit 420 has the advantage of increasing the battery life for handheld computing device 110. According to an alternative embodiment, visual display system 410 is larger than a standard handheld computing device visual display. Advantageously, the visual display can be larger without increasing the weight the user holds while viewing information because the processing unit has been detached and is not held by the user of the handheld computing device.

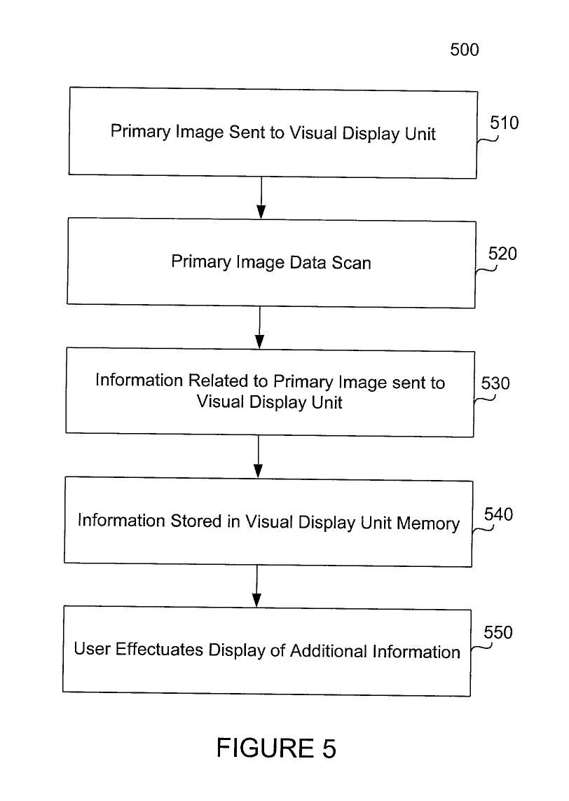

FIG. 5 is a flow diagram 500 illustrating an exemplary embodiment of a system and method for displaying data using wireless visual display system 140.

In a step 510, a primary image is wirelessly communicated from processing unit 120 over wireless connection 130 to visual display system 140. The primary image can then be displayed by visual display system 140 in display area 142. The primary image can be any information stored or generated by processing unit 120 of handheld computing device 110. According to an exemplary embodiment, the primary image can be a web page possibly containing hypertext links, thumbnail images, and data.

In a step 520, the primary image is analyzed for further information that links to additional information related to the primary image. The analysis can be performed by scanning the data. According to alternative embodiments, the data scan can be performed by processing unit processor 122 or visual display unit processor 162. The processing unit can scan the data for hypertext links, thumbnails, links in a drop-down menu, or any other information that links to additional information.

In a step 530, processing unit 120 transmits the additional information to visual display system 140 over wireless connection 130. According to an exemplary embodiment, the transmittal can occur following a request for the additional information transmitted by display unit processor 162.

In a step 540, wireless display system 140 receives the additional information and stores the additional information in display unit memory 164 using display unit processor 162.

In a step 550, the user effectuates the display of part or all of the additional information. The user can effect the display of the additional information using navigation buttons, a touch screen, or any other input method.

This method has the advantage of increasing the response time of handheld computing device 110 when the user is using the wireless display unit to access information. Additional information related to the primary image being displayed on visual display system 140 can be loaded into visual display system memory 164 using a background process while the wireless connection 130 is otherwise inactive. When the user makes a request for the additional information, it is immediately available in visual display memory 164. The user does not need to wait while the data is transferred over wireless connection 130.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A display system for a handheld computing device, the display system comprising:
a visual display having a communications transceiver;
a processing unit having a communications transceiver and sending display data to the transceiver of the visual display;
a first power source for the processing unit; and
a second power source for the visual display, wherein the visual display is physically separable from the processing unit while displaying information according to communications from the processing unit between the visual display transceiver and the processing unit transceiver.

2. The display system of claim 1, wherein the visual display includes random access memory (RAM) and a processing unit (CPU).

3. The display system of claim 2, wherein the visual display CPU receives information over the wireless connection from the handheld computing device and stores the information in the visual display RAM.

4. The display system of claim 3, where the information communicated from the processing unit to the visual display includes information necessary to display the current display image and information related to the current display image.

5. The display system of claim 4, wherein the information communicated from the processing unit to the visual display is web pages that have links in the current display.

6. The display system of claim 4, wherein the information communicated from the processing unit to the visual display is the contents of a drop down menu provided in the current display.

7. The display system of claim 4, wherein the information communicated from the processing unit to the visual display include images associated with thumbnail images displayed in the current display.

8. The display system of claim 2, wherein the visual display includes a display screen having input capabilities.

9. The display system of claim 1, wherein the visual display includes display screen that is flexible.

10. The display system of claim 1, wherein the visual display includes a display screen that is expandable.

11. The display system of claim 10, wherein the display system includes display drivers capable of updating screen resolution and screen display size based upon the current expansion of the display screen.

12. The display system of claim 1, wherein the communications transceivers send and receive information using a custom wireless communication protocol.

13. The display system of claim 1, wherein the display system includes an alternative communication system to optionally provide wired communication between the display system and the handheld computing device.

14. A handheld computing device comprising:
a detachable display system including a wireless transceiver;
a processor;
a wireless transceiver coupled to the processor and communicating with the display system transceiver; and
an information storage system.

15. The handheld computing device of claim 14, wherein the display system includes a flexible screen display.

16. The handheld computing device of claim 14, further comprising:
a first power source associated with powering the processor; and
a second power source associated with powering the detachable display system.

17. The handheld computing device of claim 16, wherein the second power source is lighter in weight than the first power source.

18. The handheld computing device of claim 14, wherein the display system includes Random Access Memory (RAM) memory.

19. The handheld computing device of claim 18, wherein the transceiver transmits information related to current display screen information to the display system to store in the display system RAM while the current display screen information is being viewed.

20. A computing system, comprising:
a processing unit, the processing unit including a first processor, a first transceiver coupled to the first processor, a first memory coupled to the first processor, and a first power source coupled to the first processor;
a first display unit, the first display unit including a first display area, a second processor, a second transceiver coupled to the second processor and communicating with the first transceiver, a second memory coupled to the second processor, and a second power source coupled to the second processor; and
a second display unit, the second display unit including a second display area, a third processor, a third transceiver coupled to the third processor and configured for communications with the first transceiver, and a third power source coupled to the third processor;
wherein the first display unit and the second display unit may be interchangably used with the processing unit.

21. The computer system of claim 20, wherein the processing unit is a handheld computing device.

22. The computer system of claim 20, wherein the first display unit requires a second power source that is lighter weight than the third power source.

23. The computer system of claim 20, wherein the first display unit is a ruggedized display unit.

24. The computer system of claim 20, wherein the first display area is a high resolution display and the second display area is a lower resolution display area.

25. The computer system of claim 20, wherein the first display unit is a non-flexible display unit and the second display unit is at least one of a flexible display unit and a foldable display unit.

26. A method of displaying data from a handheld computing device on a detached visual display unit, the method comprising:
wirelessly communicating primary images to the visual display unit;
displaying primary images on a visual display of the visual display unit while loading secondary images into a visual display unit memory; and
allowing a user of the handheld computing device to access secondary images.

27. The method of claim 26, wherein the primary images provides links to the secondary images to facilitate access.

28. The method of claim 27, wherein the links are hyperlinks.
